(19) United States
(12) Patent Application Publication
(10) Pub. No.: US 2006/0159872 A1
(43) Pub. Date: Jul. 20, 2006

(54) Ink-jet recording medium

(75) Inventors: Joseph Hubertus Olijve, Kaatsheuvel (NL); Bernadette Catharina A., M. van der Velden-Schuermans, Udenhout (NL); Iskandar Gandasasmita, Tilburg (NL); Yoichiro Kamiyama, Tilburg (NL); Akira Kase, Tilburg (NL)

Correspondence Address: BANNER & WITCOFF, LTD., 28 STATE STREET, 28th FLOOR, BOSTON, MA, 02109-9601, US

(73) Assignee: Fuji Photo Film B.V., Tilburg (NL)

(21) Appl. No.: 11/305,304

(22) Filed: Dec. 16, 2005

Related U.S. Application Data
(63) Continuation of application No. PCT/NL04/00264, filed on Apr. 20, 2004.

(30) Foreign Application Priority Data
Jun. 18, 2003 (EP) 03076901.2

(51) Int. Cl. B41M 5/00

(52) U.S. Cl. 428/32.24

(57) ABSTRACT

The present invention relates to a recording medium, in particular an ink-jet recording medium of photographic quality that has excellent ink absorption speed, good drying characteristics and a good image printing quality. According to the present invention, an ink-jet recording medium is provided, comprising a support to which at least an underlayer and an overlayer is supplied in which the underlayer is a multilayer of sublayers, comprising a mixture of gelatin and at least one type of water soluble polymer, wherein the sublayer farthest away from said support comprises a lower ratio of gelatin/water soluble polymer, compared to the ratio in the sublayer(s) nearer to the support. The present invention is further directed to methods for obtaining and using such a medium.

### FIELD OF INVENTION

The present invention relates generally to a recording medium, in particular an ink-jet recording medium of photographic quality that has excellent ink absorption speed, good drying characteristics and a good image printing quality, as well as to methods for preparing such media.

### BACKGROUND OF THE INVENTION

In a typical ink-jet recording or printing system, ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, typically is made up of water, and organic material such as monohydric alcohols and the like. An image recorded as liquid droplets requires a receptor on which the recording liquid dries quickly without running or spreading. High quality image reproduction using ink-jet printing techniques requires receptor substrates, typically sheets of paper or opaque or transparent film, that readily absorb ink droplets while preventing droplet diffusion or migration. Good absorption of ink encourages image drying while minimizing dye migration by which good sharpness of the recorded image is obtained.

There are in general two approaches for producing ink-jet recording media with photographic quality and good drying properties.

One known approach is to provide a substrate with a porous layer, which can act as the ink-receiving layer. However, this known technique may give problems as to the gloss of the paper. In specific embodiment of the known technique of substrates provided with a porous layer, there is provided on top of the porous layer a gloss enhancing layer. In this microporous type, the microporous film has as the primary function to absorb the ink solvent. The typical microporous film suitable for this purpose is described inter alia in U.S. Pat. No. 4,833,172, U.S. Pat. No. 4,861,644, U.S. Pat. No. 5,326,391

Another approach for producing ink-jet recording media with photographic quality and good drying properties is the so called “non-microporous film type”, also known as “swellable type”, as proposed in several patent publications such as EP-A-806 299 and JP-A-22 76 670. For this type of ink-jet recording medium, at least one ink receptive layer is coated on a support such as a paper or a transparent film. The ink receptive layer typically contains various proportions of water soluble polymers and fillers. The proportions of these components affect the properties of the coated layers, in particular ink absorption properties and the gloss quality appearance of the ink-jet media.

One of the important properties of an ink-jet receptive coating formulation is the liquid absorptivity. The majority, if not all, of the ink solvent has to be absorbed by the coating layer itself. Only when paper or cloth or cellulose is used as a support, some part of the solvent may be absorbed by the support. It is thus clear that both the water soluble polymer and the filler should have a significant ability to absorb the ink solvent.

US-A-2002/142141 discloses an image-receiving layer, which contains at least one water soluble polymer like polyvinyl alcohol, that swells when ink-jet ink is attached to the image-receiving layer. Improved performance with respect to durability, scuff resistance and image fidelity is said to be obtained.

In EP-A-875 393 a sheet for ink-jet recording is disclosed in which microporous polysaccharide particles are provided in an ink-receiving layer comprising for example polyvinyl alcohol. The microporous particles are said to give very good ink receptivity and also to provide good sheet feeding property in ink-jet printers.

DE-A-223 48 23 and U.S. Pat. No. 4,379,804 disclose methods in which gelatin is used in ink-receiving layers of ink-jet receiving sheets. From these documents, it has become clear that gelatin has an advantageous function for the absorption of ink solvents. The gelatin is said to improve smudge resistance, increase the definition quality, give high gloss, fast water absorbing properties, easy to achieve high water resistance and good dye fading resistance.

There are at least two major disadvantages to a gelatin-based coating, which are not much addressed in the existing art. These disadvantages include curl and brittleness of the coating.

Various countermeasures have been suggested to overcome these problems.

In WO-A-00/53406 the use of at least one plasticizer selected from the group comprising 2-pyrrolidone and its derivatives, or urea and its derivatives is described to overcome the curl and brittleness of this type coating.

Besides the curl and brittleness, other problems are encountered using ink receiving layers based on gelatin or gelatin mixtures with water soluble polymers. These are problems like beading, bleed and matte appearance at high densities. To overcome these problems various solutions have been proposed.

U.S. Pat. No. 6,183,844 describes the use of highly filled multilayers to improve bleed and wet smear resistance.

EP-A-0 742 109 describes the use of a combination of anionic and cationic fluorine containing surfactants in order to improve dot reproduction especially for graphic art applications.

EP-A-1 080 936 describes the use of a non-ionic surfactant giving a lower surface tension in the layer of an ink receptive multilayer farthest from the support and a second non ionic surfactant giving a higher surface tension in the layer nearer to the support material. Improved gloss and bleed is claimed.

EP-A-1 334 839 (published after the priority date of the present application) describes an ink recording element comprising a hydrophilic absorbing layer, which comprises a natural or synthetic polymer, such as modified gelatins or gelatin derivatives.

U.S. Pat. No. 4,946,741 describes an inkjet recording sheet comprising a transparent support having thereon an ink recording layer comprising a polyalkylene oxide and an aminogroup-deactivated gelatin derivative, such as acetyl gelatins, phthaloyl gelatins, malenoyl gelatins, benzoyl gelatins, succinoyl gelatins and methylurea gelatins.

EP-A-0 641 669 describes a recording material, which may comprise an outermost hydrophilic water-permeable layer that may contain inter alia a gelatin derivative, such as acetylated gelatin.

Although some improvement can be obtained by these known methods there remains a need for low cost ink-jet material with good image printing quality, good drying properties, improved curl and brittleness, having at the same time good behaviour on bleed, beading and matte appearance at high density parts. It is towards fulfilling this need that the present invention is directed.

### SUMMARY OF THE INVENTION

The object of the present invention is thus to provide a recording medium having good drying properties, said recording medium more in particular being suited to produce images of photographic quality.

It is another object of the present invention to provide a recording medium with reduced brittleness at low humidities and excellent curl behaviour.

It is a further object of this invention, to provide a recording medium which gives no beading and has no matte appearance at high densities and has good bleeding properties.

It has been found that these objectives can be met by providing a recording medium comprising a support and an ink receiving layer adhered to said support, where the ink receiving layer comprises at least an underlayer and an overlayer which underlayer is a multilayer of sublayers, comprising a mixture of gelatin and at least one type of water soluble polymer, wherein the sublayer farthest away from said support comprises a lower ratio of gelatin/water soluble polymer, compared to the ratio in at least one of the sublayer(s) nearer to the support.

### DETAILED DESCRIPTION

The invention is directed to a recording medium comprising a support and an ink receiving layer adhered to said support, where the ink receiving layer is a multilayer comprising at least an underlayer and an overlayer which underlayer is a multilayer of sublayers, comprising a mixture of gelatin and at least one type of water soluble polymer, wherein the sublayer farthest away from said support comprises a lower ratio of gelatin/water soluble polymer, compared to the ratio in the sublayer(s) nearer to the support. This invention is also related to the manufacturing of such a recording medium and the use of this medium. Although the invention is described herein with particular reference to inkjet printing, it will be apparent to the skilled person that the high quality recording media of the present invention are not limited to inkjet recording media (viz. media suitable to be printed on using inkjet printers), but that it is within the scope of the present invention to provide recording media that are suitable for creating high quality images by using other techniques as well, such as Gicl\acute{e}e printing, colour copying, screen printing, gravure, dye-sublimation, flexography, and the like.

In the conventional media for ink jet application comprising at least one ink receiving layer based on a water soluble polymer, such as gelatin, PVA, PEO, hydroxyethylcellulose and the like and mixtures of these polymers, it is possible to obtain good drying characteristics but it is difficult to obtain an image with photographic quality due to problems like bleed, beading, finger print smearing and matte appearance at high densities. We have now found surprisingly that these negative properties can be improved very much by using a medium on which the ink receiving layer is a multilayer, at least comprising an underlayer and an overlayer. In this type of ink receiving layer, the underlayer especially determines the physical and ink receiving properties, while the overlayer determines the surface properties like beading and gloss.

The overlayer of this invention may be a multilayer. One or more sublayers of this overlayer comprise a gelatin, preferably a modified gelatin. The overlayer may further comprise water insoluble particles inter alia to regulate the slip behaviour and optionally one or more water soluble polymers, surfactants and other additives to optimise the surface properties.

The gelatin used in the overlayer can be any gelatin whether lime-processed or acid processed made from animal collagen, preferably gelatin made from pig skin, cow skin, or cow bone or modified gelatin.

The term “modified gelatin” as used herein, refers to gelatin compounds in which at least part of the NH₂ groups is chemically modified. A variety of modified gelatins can be used in the overlayer. Good results are obtained, when at least 30% of the NH₂ groups of the gelatin is modified by a condensation reaction with a compound having at least one carboxylic group as described among others in DE-A-19721238. The compound having at least one carboxylic group can have an other functional group like a second carboxylic group and a long aliphatic tail, which in principle is not modified. Long tail in this context means from at least 5 to as much as 25 C atoms, e.g. 6-20 C atoms. This aliphatic chain can be modified still to adjust the properties like are succinic acid modified gelatins in which the succinic acid moiety contains an aliphatic chain from 5 to 25 carbon-atoms, e.g. 6 to 20 C atoms, where the chain can still be modified to a certain extend to adjust the water soluble properties or ink receptive properties. Preferably the succinic acid moiety contains an aliphatic chain from 7 to 18 carbon-atoms. Most preferred is the use of dodecylsuccinic acid modified gelatin, in which at least 30% of the NH₂ groups of the gelatin have been modified with said dodecylsuccinic acid.

Another method for obtaining modified gelatin is described in EP-A-0576911, where said gelatin is formed from gelatin containing pendant amine groups and pendant carboxylic groups wherein at least one amine group of said gelatin is modified to form an amide of the formula —NHCOR. The process typically involves reaction of an amine group with an activated carboxyl, i.e. a reaction product of a carboxyl activating agent and carboxylic acid, i.e., RCOOH wherein R represents substituted or unsubstituted alkyl of 1-10 carbons, substituted or unsubstituted aryl of 6-14 carbons, or substituted or unsubstituted arylalkyl of 7-20 carbons.

Other suitable methods are described by V. N. Izmailova, et al. (Colloid Journal, vol. 64, No. 5, 2002, page 640-642), and by 0. Toledano, et al. (Journal of Colloid and Interface Science 200, page 235-240) wherein hydrophobic groups are attached to gelatin molecules by reacting gelatin with respectively N-hydroxysuccinimide ester of caprylic acid and N-hydroxysuccinimide ester of various fatty acids (C₄-C₁₆).

Other modified gelatins giving good results are gelatins modified to have quaternairy ammonium groups. An example of such a gelatin is the “Croquat™” gelatin produced by Croda Colloids Ltd. Still another modified gelatin known in the common gelatin technology, such as phtalated gelatin and acetylated gelatins are also suitable.

The gelatin can be used alone or in combination with other water soluble polymers. Examples of these polymers include: PVA-based polymers, PVA, acetoacetylated PVA, quaternary ammonium modified PVA, copolymers and terpolymers of PVA with other polymers, cellulose derivatives such as hydroxyethyl cellulose, alkyl cellulose (e.g. methyl cellulose), hydroxyalkyl cellulose (e.g. hydroxypropyl cellulose) and carboalkyl cellulose, polyvinylpyrolidone, polyethylene oxide, polyacrylamide, copolymers and terpolymers of the polymers mentioned above, and the like. The gelatin is preferably applied to the substrate in an amount ranging from 0.1 until 8 g/m² and more preferably from 0.2 until 5 g/m², e.g. 0.5-3 g/m². The water soluble polymer is preferably applied to the substrate in an amount from 0 to 8 g/m², more preferably from 0 to 5 g/m². A suitable ratio of water soluble polymers/gelatin is between 0/1 and 4/1 which means that the overlayer may contain no water soluble polymer (apart from gelatin) or up to 4 times the amount of gelatin.

The mere application of a modified gelatin or mix of modified gelatin and water soluble polymers improves the characteristics with respect to drying and finger smearing properties. A further improvement of above mentioned properties can be obtained by including in the overlayer one or more fluorosurfactants, preferably in the amount between 2.5 mg/m² and 250 mg/m². It was found that this kind of surfactants improves amongst others the gloss and beading. Beading is defined as the phenomenon that large ink dots become visible on the printed image. The mechanism of “beading” is not clear yet. One hypothesis is that several small ink drops coalesce with each other on the surface of the ink jet media and form large ink droplets.

The term “fluorosurfactant” as used herein, refers to surfactants (viz. molecules having a hydrophilic and a hydrophobic part) that contain fluorocarbon or a combination between fluorocarbon and hydrocarbon as the hydrophobic part. Suitable fluorosurfactants may be anionic, non-ionic or cationic. Examples of suitable fluorosurfactants are: fluoro C₂-C₂₀ alkylcarboxylic acids and salts thereof, disodium N-perfluorooctanesulfonyl 3-(omega -fluoro-C₆-C₈ alkanoyl-N-ethylamino)-1-propane sulfonates, N-[3-(perfluorooctanesulfonamide)-propyl]-N,N-dimethyl-N-carboxymethylene ammonium betaine, perfluoro alkyl carboxylic acids (e.g. C₇-C₁₃-alkyl carboxylic acids) and salts thereof, perfluorooctane sulfonic acid diethanolamide, Li, K and Na perfluoro C₄-C₁₂ alkyl sulfonates, Li, K and Na N-perfluoro C₄-C₁₃ alkane sulfonyl-N-alkyl glycine, fluorosurfactants commercially available under the name Zonyl® (produced by E.I. Du Pont) that have the chemical structure of R_{f}CH₂CH₂SCH₂CH₂CO₂Li or R_{f}CH₂CH₂O (CH₂CH₂O)ₓH wherein R_{f}═F(CF₂CF₂)₃₋₈ and x=0 to 25, N-propyl-N-(2-hydroxyethyl)perfluorooctane sulfonamide, 2-sulfo-1,4-bis(fluoroalkyl)butanedioate, 1,4-bis (fluoroalkyl)-2-[2-N,N,N-trialkylammonium) alkyl amino]butanedioate, perfluoro C₆-C₁₀ alkylsulfonamide propyl sulfonyl glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine. Also useful are the fluorocarbon surfactants described e.g. in U.S. Pat. No. 4,781,985 and in U.S. Pat. No. 5,084,340.

Preferably the fluorosurfactant is chosen from Li, K and Na N-perfluoro C₄-C₁₃ alkane sulfonyl-N-alkyl glycine, 2-sulfo-1,4-bis(fluoroalkyl)butanedioate, 1,4-bis (fluoroalkyl)-2-[2-(N,N,N-trialkylammonium alkyl amino]butanedioate, perfluoroalkyl subsitituted carboxylic acids commercially available under the name Lodyne (produced by Ciba Specialty Chemicals Corp.) and fluorosurfactants commercially available under the name Zonyl® (produced by E.I. Du Pont) that have the chemical structure of R_{f}CH₂CH₂SCH₂CH₂CO₂Li or R_{f}CH₂CH₂O(CH₂CH₂O)ₓH wherein R_{f}═F(CF₂CF₂)₃₋₈ and x=0 to 25.

Beside the (modified) gelatin or (modified) gelatin/water soluble polymer mixture and fluorosurfactant(s) it may be desirable to add in the overlayer an anti-blocking agent to prevent image transfer when several printed inkjet mediums are piled up. Very suitable anti-blocking agents (also between 2 and 10 μm. The amount of matting agent is from 0.01 to 1 g/m², preferably from 0.02 to 0.5 g/m². The matting agent can be defined as particles of inorganic or organic materials capable of being dispersed in a hydrophilic organic colloid. The inorganic matting agents include oxides such as silicon oxide, titanium oxide, magnesium oxide and aluminium oxide, alkali earth metal salts such as barium sulphate, calcium carbonate, and magnesium sulphate, light-insensitive silver salt particles, and glass particles. Besides these substances one may select inorganic matting agents which are disclosed in West German Patent No. 2 529 321, British Patent Nos. 760 775 and 1 260 772, U.S. Pat. Nos. 1,201,905, 2,192,241, 3,053,662, 3,062,649, 3,257,296, 3,322,555, 3,353,958, 3,370,951, 3,411,907, 3,437,484, 3,523,022, 3,615,554, 3,635,714, 3,769,020, 4,021,245 and 4,029,504. The organic matting agents include starch, cellulose esters such as cellulose acetate propionate, cellulose ethers such as ethyl cellulose, and synthetic resins. The synthetic resins are water insoluble or sparingly soluble polymers which include a polymer of an alkyl(meth)acrylate, an alkoxyalkyl(meth)acrylate, a glycidyl(meth)acrylate, a (meth)acrylamide, a vinyl ester such as vinyl acetate, acrylonitrile, an olefin such as ethylene, or styrene and a copolymer of the above described monomer with other monomers such as acrylic acid, methacrylic acid, alpha, beta—unsaturated dicarboxylic acid, hydroxyalkyl(meth)acrylate, sulfoalkyl(meth)acrylate and styrene sulfonic acid. Further, a benzoguanamin-formaldehyde resin, an epoxy resin, nylon, polycarbonates, phenol resins, polyvinyl carbazol or polyvinylidene chloride can be used. Besides the above are used organic matting agents which are disclosed in British Patent No. 1 055 713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344, 3,591,379, 3,754,924 and 3,767,448, Japanese Patent O.P.I. Publication Nos. 49-106821/1974 and 57-14835/1982. These matting agents may be used alone or in combination.

The overlayer may optionally include thickener agents, biocides, crosslinking agents and further various conventional additives such as colorants, colored pigments, pigment dispersants, mold lubricants, permeating agents, fixing agents for ink dyes, UV absorbers, anti-oxidants, dispersing agents, non-fluorosurfactants, anti-foaming agents, leveling agents, fluidity improving agents, antiseptic agents, brightening agents, viscosity stabilizing and/or enhancing agents, pH adjusting agents, anti-mildew agents, anti-fungal agents, agents for moisture-proofing, agents for increasing the stiffness of wet paper, agents for increasing the stiffness of dry paper and anti-static agents.

The above-mentioned various additives can be added ordinarily in a range of 0 to 10 weight % based on the solid content of the ink receiving layer composition.

The underlayer typically comprises gelatin and at least one water soluble polymer and optionally additives to adjust the physical properties. This swellable underlayer determines mainly the physical properties like water uptake, drying speed, brittleness and curl. The invention is specifically related to the structure of the underlayer. By applying a different ratio of gelatin/water soluble polymer in the sublayers surprisingly the important properties beading and bleeding improved very much.

There is a variety of gelatins, both non-modified as well as modified gelatins which can be used in the underlayer. Examples of non-modified gelatins are alkali-treated gelatin (cattle bone or hide gelatin), acid-treated gelatin (pigskin, cattle/pig bone gelatin), hydrolyzed gelatin and fish gelatin. Examples of modified gelatins are aminogroup deactivated gelatin such as acetylated gelatin, phthalated gelatin, succinated gelatin, quaternary ammonium modified gelatin, et cetera. These gelatins can be used singly or in combination for forming the underlayer. Acid and alkali treated gelatins are preferred.

Water soluble polymers suitable to be mixed with the (modified) hydrolysed polyvinyl alcohol (PVA), carboxylated PVA, acetoacetylated PVA, quaternary ammonium modified PVA, copolymers and terpolymers of PVA with other polymers, watersoluble cellulose derivatives such as alkyl cellulose (e.g. methyl cellulose), hydroxyalkyl cellulose (e.g. hydroxyethyl cellulose or hydroxypropyl cellulose), carboxyalkyl cellulose (e.g. carboxymethylalkyl cellulose), dextrin, casein, gum arabic, dextran, polyacrylic acid and its copolymers or terpolymers, polymethylacrylic acid and its copolymers or terpolymers, and any other polymer, which contain monomers of carboxylic acids such as acrylic acid, methacrylic acid, maleic acid and crotonic acid, polyvinylpyrolidone (PVP), polyethylene oxide, polyacrylamide, polymers of 2-pyrrolidone and its derivatives such as N-(2-hydroxyethyl)-2-pyrrolidone and N-cyclohexyl-2-pyrrolidone, urea and its derivatives such as imidazolidinyl urea, diazolidinyl urea, 2-hydroxyethylethylene urea, and ethylene urea.

The possibilities and limitations of a mixture of gelatin and water soluble polymer is very well illustrated by means of a gelatin/PEO mixture being an example as is described below.

In order to obtain very good beading and bleeding properties it appeared surprisingly to be beneficial to use an underlayer comprising various layers, in which the various layers have a different gelatin/PEO ratio. We have found that a low gelatin/PEO ratio in the layer adjacent to the overlayer and a higher gelatin/PEO ratio at the layers nearer to the support improves bleeding and beading. More specifically gelatin/PEO ratios (wt./wt.) in the layer(s) nearest to the overlayer preferably vary between 1/4 to 4/1 and the gelatin/PEO ratios (wt./wt.) in the layer(s) nearest to the support should vary between 1/2 and 10/1 with the condition, that the gelatin/PEO ratio of the layer adjacent to the overlayer is always lower, than the ratio of the other gelatin-PEO layers. When using more gelatin-PEO layers in the underlayer it is further beneficial to use a gradient for the gelatin/PEO ratio, meaning, that the gelatin/PEO ratio is lowest in the layer adjacent to the overlayer and said

Most of the water soluble polymers have very limited compatibility with gelatin. These polymers include fully hydrolyzed or partially hydrolyzed polyvinyl alcohol, hydroxyethyl cellulose, methyl cellulose, hydroxypropyl cellulose, polyethylene oxide, polyacrylamide, and the like. When a solution of gelatin in water is mixed with a solution in water of one of the above described polymers, micro or macro phase separation occurs in solution which persists in the dried coating. The dried coating exhibits high haze, low transparency, and low gloss. It is better to use an underlayer in which no phase separation between the gelatin and the water soluble polymer occurs. A homogeneous gelatin/PEO mixture, i.e. a mixture where no phase separation occurs, may be obtained by adjusting the pH of the mixture. However there is no unique rule to determine the pH at which there is no phase separation. The best way is to follow the practical approach by making the required mixture of gelatin and water soluble polymer in water and adding alkali or acid until a homogeneous solution is obtained. The suitable pH range mainly depends on the gelatin type used and type of the water soluble polymer. It was found that acid treated gelatins having an iso-electric-point (IEP) of between 6.5 and 11 give a homogeneous solution with polyethylene oxide (PEO) at a pH below 4.5. At pH between 4.5 and 10, the mixture remains turbid, which indicate that the mixture is not homogeneous. At a pH higher than 10, a homogeneous solution can be obtained. For a lime treated gelatin, that has a typical IEP value of between 4 and 6.5, a homogeneous mixture between gelatin and PEO can be obtained at a broader pH ranges, i.e. at a pH value lower than 5 or at a pH value higher than 6.5.

In addition to the above mentioned pH adjustment, we have found, that it is not only important to have a homogeneous solution, but it is also beneficial to have a molecular weight of PEO of at least 100 000. A lower MW might also give satisfactory results, but in general most of the important properties, like curling, drying speed and brittleness improve when using a which is supplied to the substrate has a gelatin concentration between 5 and 20 wt. %.

It has been found by the present inventors that one may substitute the PEO with one or more of the other suitable water soluble polymers mentioned above. The ratio between the gelatin and said water soluble polymer(s) should be in the same ranges as it is described above for gelatin-PEO system.

Through the use of a PVA-based polymer the permanence of the images upon storage is positively influenced. In general a large variety of PVA-based polymers can be used, but the preferred PVA-based polymers are those which have been modified to give a good miscibility with water. These modifications are such, that in the PVA-based polymer back bone groups are introduced which provide a hydrogen bonding site, an ionic bonding site, carboxylic groups, sulphonyl groups, amide groups and the like, thus providing a modified PVA-based polymer. A modified PVA-based polymer giving very good results is a poly(vinyl alcohol)-co-poly(n-vinyl formamide) copolymer (PVA-NVF).

The gelatin of the underlayer is preferably used in a total amount of from 1 to 30 g/m², and more preferably from 2 to 20 g/m². The amount of water soluble polymer used in a certain formulation is typically in the range from 200 mg/m² to 30 g/m² and more preferably between 400 mg/m² and 20 g/m². When preparing the ink-jet-receiving sheet by coating a plurality of ink receiving layers, each ink-receiving layer preferably comprises an amount of gelatin ranging from 0.5 to 10 g/m².

If desired, the gelatin and/or the water soluble polymer can be cross-linked in the image-recording elements of the present invention in order to impart mechanical strength to the layer. This can be done by any cross-linking agent known in the art.

For gelatin, there is a large number of known cross-linking agents-compounds such as formaldehyde and glutaraldehyde, ketone compounds such as diacetyl and chloropentanedion, bis (2-chloroethylurea), 2-hydroxy-4,6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like. These hardeners can be used singly or in combination. The amount of hardener used, preferably ranges from 0.1 to 10 g, and more preferably from 0.1 to 7 g based on 100 g of gelatin contained in the ink-receiving layer. For PVA it is preferable to choose a cross-linking agent selected from borax, glyoxal, dicarboxylic acids and the like.

The homogeneous aqueous solution of the underlayer may further contain the following ingredients in order to improve the ink receiving layer properties with respect to ink receptivity and strength:
One or more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate and the like.
One or more fillers; both organic and inorganic particles can be used as fillers. Useful filler examples are represented by silica (colloidal silica), aluminal or alumina hydrate (aluminazol, colloidal alumina; a cat ion aluminum oxide or its hydrate and pseudo-boehmite), a surface-processed cat ion colloidal silica, aluminum silicate, magnesium silicate, magnesium carbonate, titanium dioxide, zinc oxide, calcium carbonate, kaolin, talc, clay, zinc carbonate, satin white, diatomaceous earth, synthetic amorphous silica; aluminum hydroxide, lithopone, zeolite, magnesium hydroxide and synthetic polymethacrylate, polymethyl-methacrylate, elastomers, ethylene-vinyl acetate copolymers, polyesters, polyester-copolymers, polyacrylates, polyvinylethers, polyamides, polyolefins, polysilicones, guanamine resins, polytetrafluoroethylene, elastomeric styrene-butadiene rubber (SBR), urea resins, urea-formalin resins. Such organic and inorganic fillers may be used alone or in combination.
One or more mordants. Mordants may be incorporated in the ink-receptive layer of the present invention. Such mordants are represented by cationic compounds, monomeric or polymeric, capable of complexing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha,alpha,alpha-trifluoro-m-tolyl) piperazine hydrochloride, 4-bromo-alpha,alpha,alpha-trifluoro-o-toluidine hydrochloride, difluorophenylhydrazine hydrochloride, 4-fluorobenzylamine hydrochloride, 4-fluoro-alpha,alpha-dimethylphenethylamine hydrochloride, 2-fluoroethylaminehydrochloride, 2-fluoro-1-methyl pyridinium-toluene sulfonate, 4-fluorophenethylamine hydrochloride, fluorophenylhydrazine hydrochloride, 1-(2-fluorophenyl) piperazine monohydrochloride, 1-fluoro pyridinium trifluoromethane sulfonate.
One of more light stabilising agents. Useful agents are: sterically hindered phenols, sterically hindered amines, and compounds as disclosed in GB2088777, RD 30805; RD 30362 and RD 31980. Especially suitable are water-soluble substituted piperidinium compounds as disclosed in WO02055618.
One ore more conventional additives, such as:
   pigments: white pigments such as titanium oxide, zinc oxide, talc, cobalt blue, ultramarine or phthalocyanine blue; magenta pigments or dyes such as cobalt violet, fast violet or manganese violet;
   biocides;
   pH controllers;
   preservatives;
   viscosity modifiers;
   dispersing agents;
   UV absorbing agents;
   brightening agents;
   anti-oxidants;
   antistatic agents; and/or
   anionic, cationic, non-ionic, and/or amphoteric surfactants, typically used in amounts ranging from 0.1 to 1000 mg/m², preferably from 0.5 to 100 mg/m².

These additives may be selected from known compounds and materials in accordance with the objects to be achieved.

The above-mentioned additives (plasticizers, fillers/pigments, mordants, conventional additives) may be added in a range of 0 to 30% by weight, based on the solid content of the water soluble polymers and/or gelatin in the underlayer.

The particle sizes of the non water-soluble particulate additives should not be too high, since otherwise a negative influence on the resulting surface will be obtained. The used particle size should therefore preferably be less than 10 μm, more preferably 7 μm or less. The particle size is preferably above 0.1 μm, more preferably about 1 μm or more for handling purposes.

The resulting formulation of overlayer(s) and underlayer(s) can be coated consecutively or simultaneously to a support by any method known in the art. The coating methods are for example, a curtain coating, an extrusion coating, an air-knife coating, a slide coating, a roll coating method, reverse roll coating, dip coating processes and a rod bar coating.

An important characteristic of the inkjet recording medium is the gloss. Surprisingly it has been found that the gloss of the medium can be improved by selecting the appropriate surface roughness of the used support. It was found, that providing a support having a surface roughness characterised by the value Ra being less than 1.0 μm, preferably below 0.8 μm a very glossy medium can be obtained. The Ra is measured according to DIN 4776; software package version 1.62 with the following settings: (1) Point density 500 P/mm (2) Area 5.6×4.0 mm² (3) Cut-off wavelength 0.80 mm (4) Speed 0.5 mm/sec., using a UBM equipment. The base paper to be used as the support for the present invention is selected from materials conventionally used in high quality printing paper. Generally it is based on natural wood pulp and if desired, a filler such as talc, calcium carbonate, TiO₂, BaSO₄, and the like can be added. Generally the paper also contains internal sizing agents, such as starch, alkyl ketene dimer, higher fatty acids, paraffin wax, alkenylsuccinic acid and the like. Further the paper may contain a reinforcing agent such as a polyamine, a poly-amide, polyacrylamide or starch and the like. Further additives in the paper can be fixing agents, such as aluminium sulphate, starch, cationic polymers and the like. The Ra value for a normal grade base paper is well above 1.0 μm typically above 1.3 μm. In order to obtain a base paper with a Ra value below 1.0 μm such a normal grade base paper can be coated with a pigment. Any pigment can be used. Examples of pigments are calcium-carbonate, TiO₂, BaSO₄, clay, such as kaolin, styrene-acrylic copolymer, Mg—Al-silicate, and the like. The amount being between 0.5 and 35.0 g/m² more preferably between 0.5 and 20 g/m². This pigmented coating can be applied as a pigment slurry in water together with a suitable binders like styrene-butadiene latex, methyl methacrylate-butadiene latex, polyvinyl alcohol, modified starch, polyacrylate coating, roll coating, blade coating or bar coating. The pigment coated base paper may optionally be calendered. The ink receiving multilayer of the present invention can be directly applied to the pigment coated base paper. In another embodiment, the pigment coated base paper having a pigmented top side and a back-side is provided on both sides with a polymer resin through high temperature co-extrusion giving a laminated pigment coated base paper. Typically temperatures in this co-extrusion are above 280° C. but below 350° C. The preferred polymers used are poly olefins, particularly polyethylene. In a preferred embodiment the polymer resin of the top side comprises a white pigment (metaloxide), dyes, coloured pigments, adhesion promoters, optical brighteners, antioxidant and the like to improve the whiteness of the laminated pigment coated base paper. By using other than white pigments a variety of colors of the laminated pigment coated base paper can be obtained. The total weight of the laminated pigment coated base paper is preferably between 80 and 350 g/m² The laminated pigment coated base paper shows a very good smoothness, which after applying. the ink receiving layer of the present invention results in a recording medium with excellent gloss.

Other supports used in this invention may suitably be selected from a synthetic paper or a plastic film in which the top and back coatings are balanced in order to minimise the curl behaviour.

Examples of the material of the plastic film are polyolefins such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. The support may have a gelatin subbing layer to improve coatability of the support. The support may be subjected to a corona treatment in order to improve the adhesion between the support and the ink receiving layer. Also other techniques, like plasma treatment can be

The swellable ink-receiving layer has a dry thickness from 1 to 50 micrometers, preferably from 5 to 25 and more preferably between 8 and 20 micrometers. If the thickness of said ink receiving layer is less than 1 micrometer, adequate absorption of the solvent will not be obtained. If, on the other hand, the thickness of said ink receiving layer exceeds 50 micrometers, no further increase in solvent absorptivity will be gained.

The present invention will be illustrated in more detail by the following non-limiting examples. Unless stated otherwise, all ratios given are based on weight.

### EXAMPLES

Comparative examples are indicated by “C”. Inventive examples are indicated by “E”.

A. Preparation for the Underlayer of the Ink Receiving Layer.

A 20 wt. % solution of a lime processed gelatin was prepared at pH 9. An aqueous solution of 10 wt % polyethylene oxide (PEO) having molecular weight of approximately 100 000 (from Sigma Aldrich chemicals, the Netherlands), was also prepared at pH 9. A homogeneous mixture, i.e. no phase separation, of gelatin and PEO having a weight ratio of 6:1 was made by adding 143 weight parts of said PEO solution and 429 weight parts of water into 428 weight parts of said gelatin solution at a temperature of 40° C. This mixture was agitated gently for about 30 minutes.

Mixtures having various gelatin/PEO ratios were made by varying the amount of the above mentioned components, i.e. said gelatin solution, said PEO solution and water. All other procedures were kept the same.

In the examples the underlayer was divided into several layers (sublayers) in order to have a different gelatin/water soluble polymer ratio in the underlayer. For instance in the case of Comparative example C-1 sublayer1, coated on the substrate, contains a Gel/PEO ratio (wt./wt.) of 2:1, (wt./wt.) of 2:1 and sublayer3, coated on the top of sublayer2, contains a Gel/PEO ratio (wt./wt.) of 6:1. In this case the layer farthest away from the support, sublayer3, has the highest gelatin/PEO ratio which is not according the invention. In inventive example E-1 both sublayer 1 and 2 contain a gelatin/PEO ratio of 6:1 while sublayer 3 contains a gelatin/PEO ratio of 4:1 which is lower than the ratio in the other sublayers and is according the invention. An improved behaviour concerning beading and bleeding is resulting from this modification.

In Examples 5-10, the PEO has been gradually substituted with another water soluble polymer or a mixture of two water soluble polymers, starting from the sublayer 3. So in the example E-5, a mixture of gelatin and water soluble polymers for sublayer 3 was prepared in the weight ratio of 3 tol. Said water soluble polymers contained 75 wt. % of PEO and 25 wt. % polyvinylpyrollidone (PVP) having molecular weight of about 30 000 Daltons (ICN Biochemicals). The weight ratio of PEO and PVP in sublayer 3 was decreased in example E-6 to E-8 to respectively 27:75, 50:50 and 0:50. In example E-9, the water soluble polymers for sublayer 1 and sublayer 2 contained also PEO-PVP mixture in the ratio of 50:50. And finally the effect of Gelatin-PVA mixture was given in example E-10.

B. Preparation for the Overlayer of the Ink Receiving Layer.

A solution containing 100 weight parts of modified gelatin (see Table 1) and 900 weight parts of water was prepared at 40° C. The pH of the solution was adjusted to 8.5 by adding NaOH.

C. Coating the Ink Receiving Layers.

The underlayer and overlayer solutions mentioned above were fed into a slide coating machine, commonly known in the photographic industry, and coated on a photographic grade paper having polyethylene laminated at after drying, the total solid content of the sublayer(s) (=gelatin+other water soluble polymer) was varied between 8 to 15 g/m² and that of the overlayer was between 0.5 and 5 g/m². After coating, the solution was chilled at a temperature of ca. 12° C. to set the gelatin and then dried with dry air at a maximum temperature of 40° C.

D. Schematic Drawing and Definition of the Layer Structure:

### D-1. Multi Layer Underlayer and Overlayer Structure

| | Overlayer |
|---|---|
| Underlayer | Sublayer 3 |
| | Sublayer 2 |
| | Sublayer 1 |
| | Laminated Substrate |

In Table 1 two types of modified gelatin are listed that were used for the overlayer formulation as described in B.

TABLE 1

| Gelatin | | Modification |
|---|---|---|
| type | Type of modification | load [%] |
| A | Dodecyl-succinic modified acid treated gelatin | ca. 40% |
| | from Stoess GmbH, Germany | |
| B | “Croquat S”, a C18 quaternair ammonia modified | 80%-100% |
| | lime bone gelatin, Croda Colloids Ltd., UK. | |

### Example 1-4

In this set of examples the effect of different gelatin-PEO ratios on the print quality is investigated. The underlayer is split-up into 3 sublayers.

| | Sublayer 1 | | Sublayer 2 | | Sublayer 3 | | |
|---|---|---|---|---|---|---|---|
| | Gel/PEO | Solid | Gel/PEO | Solid | Gel/PEO | Solid | Overlayer |
| | Ratio | content | ratio | content | ratio | content | Gelatin type |
| Example | (wt./wt.) | g/m² | (wt./wt.) | g/m² | (wt./wt.) | g/m² | [solid content] |
| C-1 | 2:1 | 5 | 2:1 | 5 | 6:1 | 4 | A [2 g/m²] |
| C-2 | 2:1 | 5 | 6:1 | 5 | 6:1 | 4 | A [2 g/m²] |
| C-3 | 6:1 | 4 | 6:1 | 4 | 10:1 | 4 | A [2 g/m²] |
| E-1 | 6:1 | 4 | 6:1 | 4 | 4:1 | 4 | A [2 g/m²] |
| E-2 | 6:1 | 5 | 6:1 | 4 | 3:1 | 3 | A [2 g/m²] |
| E-3 | 10:1 | 5 | 6:1 | 4 | 2:1 | 3 | A [2 g/m²] |
| E-4 | 6:1 | 5 | 6:1 | 4 | 2:1 | 3 | B [2 g/m²] |

In Examples 5-10 the PEO was partly or totally replaced by other water soluble polymers.

| | sublayer 1 | | Sublayer 2 | | Sublayer 3 | | |
|---|---|---|---|---|---|---|---|
| | Gel/Water | Solid | Gel/Water | Solid | Gel/Water | Solid | Overlayer |
| | soluble | content | soluble | content | soluble | content | Gelatin type |
| Example | polymer | g/m² | polymer | g/m² | polymer(s) | g/m² | [solid content] |
| E-5 | a) | 5 | a) | 4 | c) | 3 | A [2 g/m²] |
| E-6 | a) | 5 | a) | 4 | d) | 3 | A [2 g/m²] |
| E-7 | a) | 5 | a) | 4 | e) | 3 | A [2 g/m²] |
| E-8 | a) | 5 | a) | 4 | f) | 3 | A [2 g/m²] |
| E-9 | b) | 5 | b) | 4 | e) | 3 | A [2 g/m²] |
| E-10 | a) | 5 | a) | 4 | g) | 3 | A [2 g/m²] |

a) Gel:PEO = 6:1 (wt./wt.)
b) Gel:(PEO-PVP) = 6:1 (wt./wt.); PEO:PVP = 50:50 (wt./wt.)
c) Gel:(PEO-PVP) = 3:1 (wt./wt.); PEO:PVP = 75:25 (wt./wt.)
d) Gel:(PEO-PVP) = 3:1 (wt./wt.); PEO:PVP = 25:75 (wt./wt.)
e) Gel:(PEO-PVP) = 3:1 (wt./wt.); PEO:PVP = 50:50 (wt./wt.)
f) Gel:PVP = 3:1 (wt./wt.)
g) Gel:PVA = 3:1 (wt./wt.)

E. Evaluation of the Printed Image on the Media

The ink jet media prepared by the above mentioned formulation and said coating process, were printed with a standard image comprising black, cyan, magenta and yellow bars. The image contained also two pictures; including a portrait picture and a composition picture. The image was printed at a room conditions (23° C. and 48% Relative Humidity (RH)) and the printed materials were kept at this condition for at least 1 hour to dry.

A HP Deskjet® 995c was used to print the images by using the following settings:
Print quality: best
Selected Paper type: HP premium plus photo paper, glossy
Other parameters were according to the factory setting.

The quality of the printed images were further analysed visually by analysing the beading behaviour, the glossiness of especially the black area, the dryness of especially the black area, and the bleeding behaviour after some period of time. For all tests the printer was equipped with its original ink.

F. Definitions of the Image Evaluation

1. Beading Behaviour

As set out hereinabove, beading is defined as the phenomenon that large ink dots that become visible on the printed image. The following classification has been defined:
ο: no beading is observed
Δ: some small spots which is not very visible and/or beading that can be solved by selecting another printer settings.
×: Clearly visible 2. Glossiness After Printing.

The glossiness of the image directly after printing and after two days the print (e.g. black colour). The more reflection was observed, the glossier the printed image. The following classification was defined for judging the Glossiness:
ο: Still glossy after 2 days without any defects
Δ: Gloss after printing, but after 2 days some ‘matte” spots was observed.
×: Matte appearance after printing, or a lot of “matte” spots after 2 days.

3. Dryness

The dryness of the image was analysed by putting 10 sheets of A-4 white paper on the printed image for about 30 minutes.
ο: Good drying=no ink transfer observed on the white paper
Δ: Acceptable=some vague (low density) ink transfer
×: Bad=ink transfer was clearly visible

4. Bleeding Behaviour.

For this analysis, the printed images were further conditioned at a temperature of 25° C. and 90% relative humidity for 2 days. Thereafter, the images were analysed visually for colour diffusion.
ο: No colour diffusion is observed.
Δ: Acceptable. The result is not bad but also not perfect.
×: Clear colour diffusion.

Result of Example 1-4: Effect of gelatin-PEO ratio in the underlayer

| Example | Beading | Glossiness | Dryness | Bleeding |
|---|---|---|---|---|
| C-1 | Δ˜◯ | ◯ | ◯ | Δ |
| C-2 | Δ | ◯ | ◯ | ◯ |
| C-3 | Δ | ◯ | Δ | ◯ |
| E-1 | ◯ | ◯ | ◯ | ◯ |
| E-2 | ◯ | ◯ | ◯ | ◯ |
| E-3 | ◯ | ◯ | ◯ | ◯ |
| E-4 | ◯ | ◯ | ◯ | ◯ |

Result of Example 5-10: Effect of mixture between gelatin with various water soluble polymers

| Example | Beading | Glossiness | Dryness | Bleeding |
|---|---|---|---|---|
| E-5 | ◯ | ◯ | ◯ | ◯ |
| E-6 | ◯ | ◯ | ◯ | ◯ |
| E-7 | ◯ | ◯ | ◯ | ◯ |
| E-8 | ◯ | ◯ | ◯ | ◯ |
| E-9 | ◯ | ◯ | ◯ | ◯ |
| E-10 | ◯ | ◯ | ◯ | ◯ |

1. A recording medium comprising a support and an ink-receiving layer adhered to said support, where the ink receiving layer comprises at least one underlayer and at least one overlayer, which overlayer comprises a modified gelatin, wherein said underlayer is a multilayer of sublayers, comprising a mixture of non-modified gelatin and at least one type of other water soluble polymer, wherein the sublayer farthest away from said support comprises a lower ratio of gelatin/water soluble polymer, compared to said ratio in the sublayer(s) nearer to the support.

2. The medium according to claim 1, wherein said modified gelatin is selected from the group consisting of alkali-treated gelatin, acid-treated gelatin, gelatin derivatives and mixtures thereof, wherein said gelatin derivatives is a member selected from the group consisting of acetylated gelatin, phthalated gelatin, succinated gelatin, quaternary ammonium modified gelatin, and mixtures thereof.

3. The medium according to claim 1, wherein said water soluble polymer is a member selected from the group consisting of PVA-based polymers, substituted alkyl cellulose, polyethylene oxide (PEO), polyacrylamide, polyvinylpyrrolidone (PVP), and mixtures thereof.

4. The medium according to claim 3, wherein said water soluble polymer is selected from poly(vinyl alcohol-co-poly(n-vinyl formamide) copolymer (PVA-NVF), acetoacetylated PVA, quaternary ammonium modified PVA, and mixtures thereof.

5. The medium according to claim 1, wherein at least one underlayer comprises a mixture of gelatin and a water soluble polymer with a weight ratio of 1:4 to 10:1.

6. The medium according to claim 5, wherein the sublayer farthest away from the support comprises a mixture of gelatin and a water soluble polymer with a weight ratio of 1:4 to 4:1 and the sublayer(s) nearer to the support comprise at least a mixture of gelatin and a water soluble polymer with a weight ratio of 1:2 to 10:1.

7. The medium according to claim 1, wherein the amount of said gelatin in the underlayer is from 1 to 30 g/m².

8. The medium according to claim 1 in which at least one of said overlayers comprises a modified gelatin selected from the group consisting of acetylated gelatin, phthalated gelatin, alkyl quaternary ammonium modified gelatin, succinated gelatin, alkylsuccinated gelatin, gelatin chemically modified with N-hydroxysuccinimide ester of fatty acid, and combinations thereof.

9. The medium according to claim 8, wherein said modified gelatin is a succinated gelatin comprising a C₅-C₂₅ alkyl group, a C₅-C₂₅ fatty acid group, or both.

10. The medium according to claim 8 in which the modified gelatin in said overlayers is used in an amount of 0.1 to 8.0 g/m².

11. The medium according to claim 1, wherein said ink receiving layer has a thickness of between 1 and 50 μm.

12. The medium according to claim 1, wherein the support is selected from paper, a base paper, a pigment coated base paper, a laminated pigment coated base paper, a laminated paper, a synthetic paper or a film support.

13. The medium according to claim 12, wherein the support has a surface roughness Ra smaller than 1.0 μm.

14. The medium according to claim 1, where the support has a weight of between 80 and 350 g/m₂.

15. A process for producing a recording medium, comprising the steps of:
a. preparation of at least two aqueous mixtures of at least a non-modified gelatin, a water soluble polymer, and optionally one or more additives for the underlayer;
b. preparation of at least one mixture for the overlayer comprising a modified gelatin; and
c. coating said mixtures consecutively or simultaneously on said support using curtain coating, extrusion coating, air-knife coating, slide coating, a roll coating method, reverse roll coating, dip coating processes, or a rod bar coating, followed by drying the coated support.

16. The recording medium according to claim 1, wherein said recording medium is an ink-jet recording medium, Giclée printing recording medium, color copying recording medium, screen printing recording medium, gravure recording medium, dye-sublimation recording medium or flexography recording medium.

17. A method of forming a permanent, precise ink-jet image comprising the steps of:
a. providing a recording medium as defined in claim 1; and
b. bringing ink into contact with the medium in the pattern of a desired image.

18. The medium according to claim 1, wherein the amount of said gelatin in the underlayer is from 2 to 20 g/m².

19. The medium according to claim 8, wherein said modified gelatin is a succinated gelatin comprising a C₇-C₁₈ alkyl group, a C₇-C₁₈ fatty acid group, or both.

20. The medium according to claim 8 in which the modified gelatin in said overlayers is used in an amount of 0.2 to 5.0 g/m².

21. The medium according to claim 1, wherein said ink receiving layer has a thickness of between 5 and 25 μm.

22. The medium according to claim 1, wherein said ink receiving layer has a thickness of between 8 and 20 μm.

23. The medium according to claim 12, wherein the support has a surface roughness Ra smaller than 0.8 μm.
